(19) United States
(12) Patent Application Publication
(10) Pub. No.: US 2026/0320587 A1
(43) Pub. Date: Oct. 15, 2026

(54) SECURING BROWSER EXTENSION CRYPTO WALLETS USING A HARDWARE DONGLE

(71) Applicant: Thirdwayv, Inc., Irvine, CA (US)

(72) Inventors: Nabil Wasily, Foothill Ranch, CA (US); Michael Atef Ayoub, Irvine, CA (US)

(73) Assignee: Thirdwayv, Inc., Irvine, CA (US)

(21) Appl. No.: 19/101,214

(22) PCT Filed: Sep. 27, 2023
(86) PCT No.: PCT/US2023/033897

§ 371 Date: Feb. 4, 2025

Related U.S. Application Data
(60) Provisional application No. 63/410,583, filed on Sep. 27, 2022.

(51) Int. Cl. G06Q 20/36

(52) U.S. Cl. CPC G06Q 20/3674

(57) ABSTRACT

Cryptocurrency transactions are increasing in prevalence. An important security practice for cryptocurrency transactions includes maintaining a cryptowallet with a private key for signing cryptocurrency transactions. Hardware-based cryptowallets with a secure element retaining the private key are highly secure. However, hardware-based cryptowallets can be bulky due to the need to have a human-readable interface for verification of transaction details. An improved hardware-based cryptowallet is provided that omits the human-readable interface and utilizes a wirelessly connected authentication device, such as a smartphone, to provide a display screen for a user. In this manner, a transaction may be secured without needing a hardware wallet with a bulky or unwieldy form-factor.

### CROSS-REFERENCE TO RELATED APPLICATIONS

This application is based upon and claims the benefit and priority to U.S. Provisional Patent Application No. 63/410,583 entitled “SECURING BROWSER EXTENSION CRYPTO WALLETS USING USB DONGLE,” filed on Sep. 27, 2022, the entire content of which is incorporated herein by reference.

### FIELD

The present invention is directed to cryptowallets, and more specifically, the present disclosure is directed to secure hardware for use with browser extension cryptowallets.

### BACKGROUND

Cryptowallets are used to generate and store the cryptographic keys required for performing cryptocurrency transactions. The private keys of a cryptowallet are usually generated via a deterministic hierarchical scheme based on one master secret, called the seed value. In addition to a cryptographic seed value, a private key and/or a wallet personal-identification-number (PIN) code are also important to maintain securely. If the seed value, private key, and/or wallet PIN code are leaked or compromised, a hacker may gain control of the cryptowallet and/or initiate unwanted transactions.

### SUMMARY

A hardware wallet dongle is provided. The hardware wallet dongle may be for a secure browser extension cryptowallet system for securing cryptocurrency transactions in a browser extension wallet. The hardware dongle may include a secure element configured to protect a private key of a user. The hardware dongle may include a first communication interface to connect the hardware wallet dongle in electronic communication with a browsing device running the browser extension wallet. The hardware dongle may include a second communication interface to connect the hardware wallet dongle in electronic communication with an authentication device. The first communication interface and the second communication interface may both be connected to the secure element. The secure element may sign a transaction and transmit the signed transaction to the first communication interface for provision to the browser extension wallet in response to a first authentication message from the authentication device being received by the second communication interface and verified by the secure element as authentic.

One or more further features may also be included. In various embodiments, the authentication device is a smartphone. In various embodiments, the first communication interface is a wired interface. The wired interface may be a Universal Serial Bus interface. The second communication interface may be a wireless interface. In various embodiments, the hardware wallet dongle does not include a screen display. In various embodiments, the hardware wallet dongle includes no human-readable interface. In various embodiments, the first authentication message is a confirmation of a user identity by at least one biometric sensor.

A secure browser extension cryptowallet system is provided. The system may be for securing cryptocurrency transactions in a browser extension wallet. The system may include a hardware wallet dongle. The hardware wallet dongle may be for a secure browser extension cryptowallet system for securing cryptocurrency transactions in a browser extension wallet. The hardware wallet dongle may include a secure element configured to protect a private key of a user. The hardware wallet dongle may include a first communication interface to connect the hardware wallet dongle in electronic communication with a browsing device running the browser extension wallet. The hardware wallet dongle may include a second communication interface to connect the hardware wallet dongle in electronic communication with an authentication device. The first communication interface and the second communication interface are both connected to the secure element. The secure element signs a transaction and transmits the signed transaction to the first communication interface for provision to the browser extension wallet in response to a first authentication message from the authentication device being received by the second communication interface and verified by the secure element as authentic. The browsing device may be running the browser extension wallet. The browsing device is connected to a network having access to a blockchain to write the signed transaction to the blockchain. A smartphone may be running a smartphone application and may be the authentication device. The authentication device includes a biometric sensor. The first authentication message is an authentication of an identity of the user by the biometric sensor.

One or more further features may also be included. In various embodiments, the biometric sensor is a fingerprint sensor. In various embodiments, the biometric sensor is a facial recognition sensor. The sensor may be a touch screen for entering a PIN code. In various embodiments, the browsing device is a commodity PC. The authentication device may be a smartphone. The first communication interface may be a wired interface. The wired interface may be a Universal Serial Bus interface. The second communication interface may be a wireless interface. In various embodiments, the hardware wallet dongle does not include a screen display. In various embodiments, the hardware wallet dongle includes no human-readable interface.

A method of performing a cryptocurrency transaction is provided. The transaction may be performed with a secure browser extension cryptowallet system for securing cryptocurrency transactions in a browser extension wallet. The method may include sending, by the browser extension wallet running on a browser device, a cryptocurrency transaction to a hardware wallet dongle connected to the browser device via a first communication interface. The method may include receiving, by a secure element of the hardware wallet dongle, the transaction, parsing the transaction, and generating a visible representation of the transaction. The method may include sending, by the secure element, the visible representation to a second communication interface wirelessly connectable to an authentication device. The method may include receiving, by the secure element, a first authentication message from the second communication interface, the first authentication message corresponding to a verification by the authentication device of an identity of a user. The method may include signing, by the secure element, the transaction in response to the first authentication message. The method may include transmitting, by the secure element, the signed transaction to the browser extension wallet via the first communication interface, for writing the signed transaction to a blockchain by the browser extension wallet. In various embodiments, the visible representation is a transaction amount and a receiver address.

### BRIEF DESCRIPTION OF THE FIGURES

A more complete understanding of the present invention may be derived by referring to the detailed description and claims when considered in connection with the Figures, where like reference numbers refer to similar elements throughout the Figures, and:

FIG. 1 is a diagram of components of a secure browser-based cryptowallet system, in accordance with various embodiments;

FIG. 2 is a diagram of components of a hardware wallet dongle of a secure browser-based cryptowallet system, in accordance with various embodiments;

FIG. 3 is a diagram of components of a hardware wallet dongle of a secure browser-based cryptowallet system having a sensor on the hardware wallet dongle, in accordance with various embodiments;

FIG. 4 depicts a method of configuring a system for secure transactions, in accordance with various embodiments; and

FIG. 5 depicts a method of performing a cryptocurrency transaction with a secure browser-based cryptowallet system, in accordance with various embodiments.

### DETAILED DESCRIPTION

The following description is of various exemplary embodiments only, and is not intended to limit the scope, applicability, or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

Cryptowallets are used to generate and store cryptographic keys required for performing cryptocurrency transactions. Cryptowallets include at least two common varieties. Software wallets are cryptowallets that are a smartphone or desktop application that stores the cryptographic keys and also manages incoming and outgoing transactions. Hardware wallets are cryptowallets that have an embedded device, such as a secure element (SE), that stores the private keys used for signing outgoing transactions. The hardware wallet communicates with a smartphone, desktop, or web application “watch-only wallet” that only stores the corresponding public keys of the hardware wallet's private keys. A watch-only wallet monitors incoming transactions and prepares unsigned outgoing transactions for the embedded device but cannot sign outgoing transactions. The embedded device verifies the transaction details, retrieves the applicable signing key, signs the transaction, and sends the signed transaction back to the smartphone, desktop, or web application to be broadcast to mining nodes.

Hardware cryptowallets are known to be more secure than software cryptowallets because the software cryptowallets coexist with other applications on a smartphone or desktop and thus the private keys are susceptible to software attacks on the shared platform, while the keys in a hardware cryptowallet never leave the embedded device. Access to hardware cryptowallet operations is often protected by a personal identification number (PIN) or sensed biometric such as a fingerprint or facial recognition.

Private keys of a cryptowallet may be generated via a deterministic hierarchical scheme based on one master secret. The master secret is called the seed value. This seed value is important and must be maintained securely. The private keys must also be maintained securely. Moreover, a user may, in some instances, be required to enter a PIN code associated with the cryptowallet to authorize various transactions. The PIN code should also be maintained securely.

In parallel with these security requirements, wallet users also desire operational convenience. One way to increase convenience is to perform cryptowallet transactions on a web browser. However, while a web browser increases convenience, it also introduces security risks.

Thus, performing cryptowallet transactions on a web browser is difficult for various reasons. For instance, browser software is built on an operating system (for example, Windows or Apple) that controls and oversees the operation of applications such as wallet software applications. Malware or malicious software can compromise the operation of applications and/or operating systems. Malicious firmware can compromise the operation and security of computer storage components such as electronic memory and user interface (UI) components such as displays and touch controllers.

These attacks can lead to compromise of user input and output to/from the computer UI as well as storage of wallet secrets in a smartphone electronic memory. Such compromise may lead to a malicious attacker gaining access to the cryptowallet private key, seed phrase, and/or wallet PIN code. An attacker can compromise a user transaction input or output, permitting an attacker to change a cryptocurrency transaction recipient or a cryptocurrency transaction amount.

A popular form of a cryptocurrency wallet is a browser extension wallet which runs software from inside a browser. These wallets usually run on a computer and enable an interactive Web3 user experience. One problem with this type of wallet is protecting the security of storing a cryptographic private key, using a key to sign a transaction, and confirming a transaction. One reason is the susceptibility of computer platforms and especially web browsers to cyber security attacks. A USB wallet with a screen on the USB wallet device is one solution. However, this device is inconvenient. First, the form-factor requires connecting the USB wallet to the computer using a USB cable and having the wallet sitting on a desk or dangling. This is inconvenient and limits mobility for a laptop. Furthermore, providing a screen on the USB device is costly.

Thus, the disclosure herein provides a security solution for browser extension cryptocurrency wallets having a small form factor that could be implemented in the form of a small USB dongle. The disclosure further provides that a secure element of a USB dongle stores a private key and/or seed phrase, parses a cryptocurrency transaction, and/or generates a visible representation of a transaction for presentation to a user on a smartphone device. The disclosure provides a Bluetooth low energy (BLE) radio that connects the USB dongle to a smartphone running a corresponding application, the corresponding application presenting a visible representation of a transaction and facilitating sending by a user of a confirmation or rejection of a transaction to the secure element over Bluetooth low energy (BLE) communication. The disclosure further provides a touch-button or fingerprint touch-ID module connected to the secure element that proves to the secure element that an appropriate user of the system is present and is aware of a transaction being performed. In some instances, the touch-button or fingerprint touch-ID module, or another sensor is on a different device such as a separate authentication device. The disclosure includes a USB interface to communicate to a browser extension wallet from a USB dongle. The disclosure provides a visual indicator such as a light-emitting diode (LED) that shows the user that activity is occurring on the USB dongle.

This disclosure includes systems and methods to address both convenience concerns and security concerns, while avoiding bulky or awkward hardware-based wallet devices. This disclosure provides a hardware solution that isolates cryptowallet operations. This disclosure preserves the current form-factor of a computer by avoiding use of large or unwieldy USB devices or USB devices with large screen displays (for instance, traditional hardware wallets).

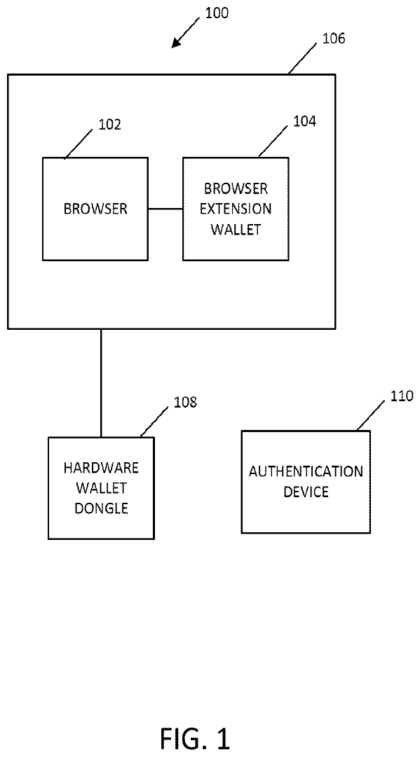

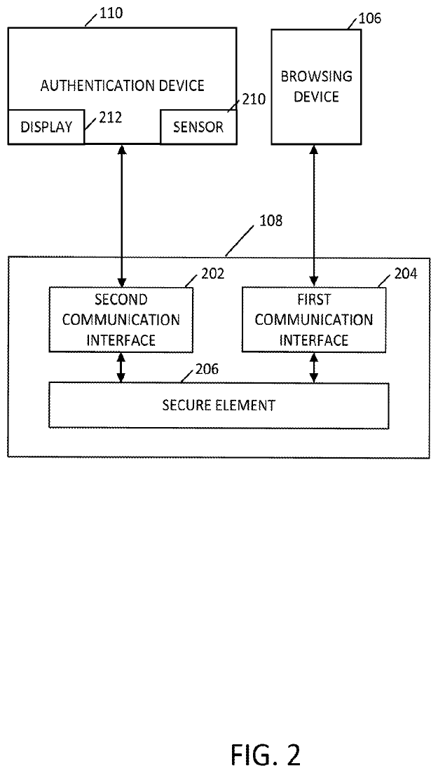

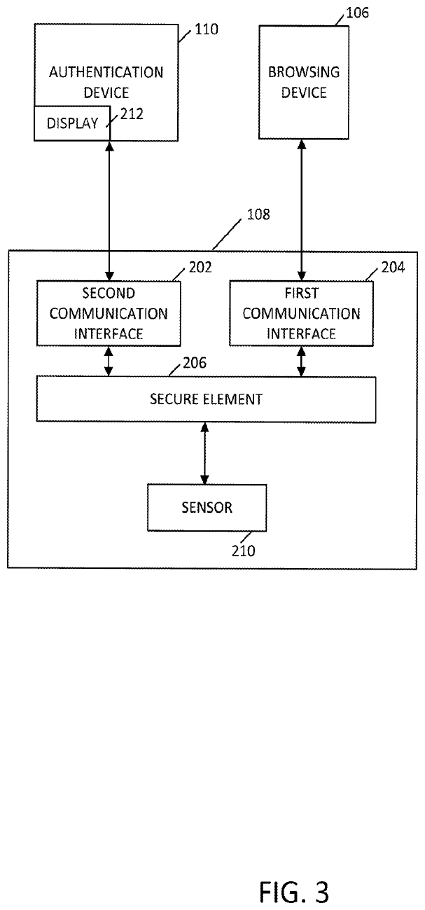

With reference to FIG. 1, a secure browser extension cryptowallet system 100 (“system” 100) is illustrated in block diagram form. The system 100 includes a browsing device 106. The browsing device 106 may be a computer, or may be a handheld computer, or may be an application-specific integrated circuit (ASIC) device or may be any other computing platform as desired. The browsing device 106 may be connected to a hardware wallet dongle 108. The hardware wallet dongle 108 comprises a peripheral that is connectable to the browsing device 106 and provides a secure storage and/or secure execution environment for computer data or code to be stored or executed without potential interception, code injection, unwanted access, or other nefarious compromise. The hardware wallet dongle 108 may provide a secure element configured to protect a private key of a user, such as for asymmetric cryptographic keys. Finally, the system 100 may interoperate with an authentication device 110. The authentication device 110 may comprise a smartphone device such as a phone that can run applications, or the authentication device 110 may be a dedicated purpose computing device that solely interacts with the secure browser extension cryptowallet system 100. The authentication device 110 may be in wireless communication with the hardware wallet dongle 108 and may provide a user readable interface for the hardware wallet dongle 108. Thus, the authentication device 110 may have a display 212 (FIGS. 2-3), wherein an application running on the authentication device 110 may interact with the hardware wallet dongle 108 so that the hardware wallet dongle 108 can provide data to the authentication device 110 for review by a user on a user-readable interface device such as a display 212 (FIGS. 2-3). In further examples, the authentication device 110 may provide a mechanism for a user to approve or reject proposed transactions associated with the data being reviewed on the user-readable interface device and the authentication device 110 may transmit data representative of this approval or rejection to the hardware wallet dongle 108. For instance, the display 212 (FIGS. 2-3) may be a touch-screen.

With continuing reference to FIG. 1 but also with reference to FIGS. 2 and 3, as briefly mentioned, the system 100 includes a browsing device 106. The browsing device 106 may be a commodity personal computer (“PC”). The browsing device 106 may include a browser 102 and a browser extension wallet 104. A browser 102 may comprise a software application that permits the browsing device 106 to access network resources such as websites, remote computers, Web3 applications, blockchain resources, and the like. The system 100 may also include a browser extension wallet 104. A browser extension wallet 104 is a software-based cryptocurrency wallet that integrates into a browser 102 of a browsing device 106.

As also briefly mentioned, the system 100 includes a hardware wallet dongle 108. The hardware wallet dongle 108 comprises a hardware device that connects to the browsing device 106. The hardware wallet dongle 108 may connect via a universal serial bus (USB) or other connection type. Thus, the hardware wallet dongle 108 may have a first communication interface 204. The first communication interface 204 may be a universal serial bus connection interface. The first communication interface 204 connects the hardware wallet dongle 108 in electronic communication with the browsing device 106, and correspondingly, the browser extension wallet 104 of the browsing device 106. The hardware wallet dongle 108 may also have a second communication interface 202. The second communication interface 202 connects the hardware wallet dongle 108 in electronic communication with the authentication device 110. In this manner, the hardware wallet dongle 108 may utilize a display 212 of the authentication device 110.

The hardware wallet dongle 108 may include a secure element 206. A secure element 206 (SE) is a tamper-resistant platform capable of securely hosting applications and their confidential and cryptograph data. For instance, a secure element 206 may have a memory and or processor for storage of seeds, or private keys and for execution of cryptographic operations with seeds or private keys. For instance, one or more of key pairs may be generated within the SE, for enhanced security, such that the key is hardware-backed and cannot be retrieved outside a SE. In various instances, one or more of the private keys are retained in a SE. This also facilitates improved security. By retaining the key within the SE, the key is secured from retrieval outside the SE, but may still be utilized for cryptographic operations. The secure element may store a private key (seed phrase), parse a cryptocurrency transaction, generate visible representation of the transaction to be presented to a user, and/or receive user confirmation via a push-button or other input connected to secure element.

Finally, the hardware wallet dongle 108 may have a sensor 210. FIG. 2 illustrates a hardware wallet dongle 108 with a sensor 210. In other instances, FIG. 3 illustrates that the authentication device 110 has the sensor 210. Referring now to both FIGS. 2 and 3, the sensor 210 may comprise an identity verification sensor, such as a biometric sensor or a code entry mechanism. The biometric sensor may be a fingerprint recognizing touch sensor (e.g., touch-ID) or a face recognizing optical sensor (e.g., face-ID). In this manner, the identity of the user that is interacting with the hardware wallet dongle 108 and/or the authentication device 110 in connection with a transaction of the browser extension wallet 104, may be verified, thus ameliorating a risk of unwanted or nefarious transactions.

Notably, the hardware wallet dongle 108, in various embodiments, does not include a screen display. The hardware wallet dongle 108, in various embodiments, includes no human-readable interface. In this manner, the hardware wallet dongle 108 may be significantly more compact and convenient than a hardware wallet having a human-readable interface connected directly to a secure element.

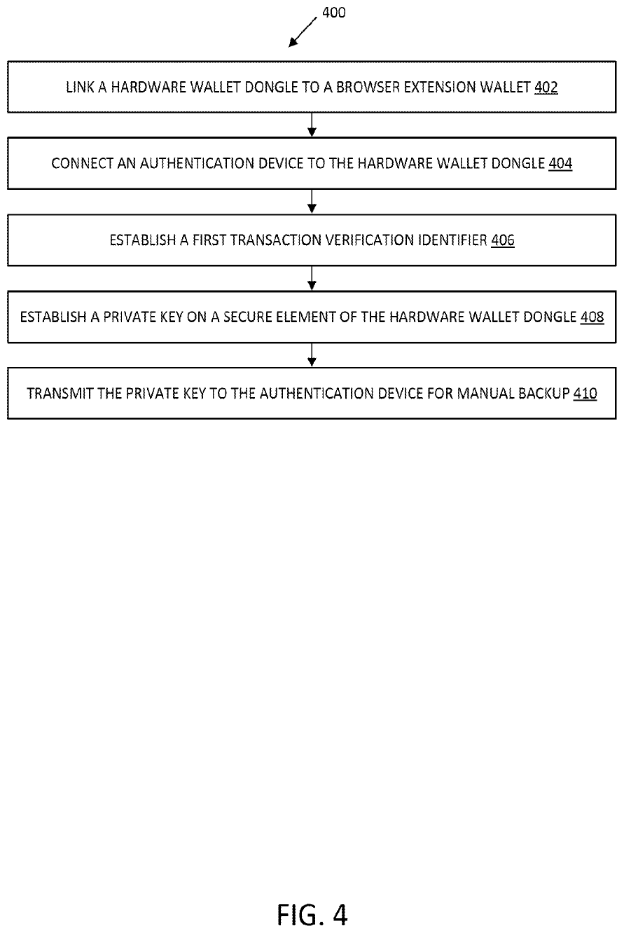

The combination of components may interoperate according to different methods. For instance, FIG. 4 describes one example method 400 of a configuring a system for secure transactions using the aforementioned system. A user may link a hardware wallet dongle to a browser extension wallet (block 402). For instance, a user may connect the dongle to a browsing device having the browser extension wallet. A user may connect an authentication device to the hardware wallet dongle (block 404). For instance, a user may connect a smartphone having a smartphone application configured to communicate with the hardware wallet dongle, to the hardware wallet dongle, via a Bluetooth low energy (BLE) or other wireless connection. A user may establish a first transaction verification identifier, such as a facial recognition, fingerprint recognition, or passcode identifier for entry into the smartphone application configured to communicate with the hardware wallet dongle (or for entry directly into a sensor of the hardware wallet dongle) (block 406). The hardware wallet dongle may establish a private key (e.g., seed phrase) on the secure element (block 408). In various instances, establishing a private key includes cryptographically generating the private key by the secure element. In further instances, establishing a private key may include a user loading a seed phrase onto the hardware wallet device via a USB connection to the browsing device, or via a Bluetooth low energy (BLE) connection to a smartphone. Similarly, the key may be loaded via a manual entry over BLE, USB, or near field communication. Optionally, this key is transmitted one time to the authentication device for visual display to a user for manual backup (block 410). In other instances, this key is not transmitted.

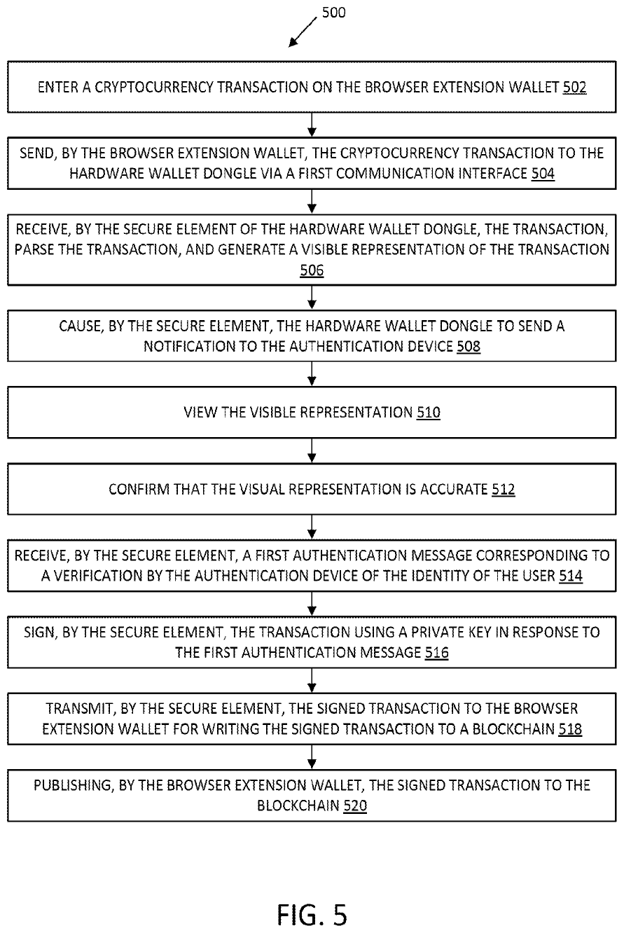

The devices are now configured for the execution of cryptographic transactions. To execute a cryptographic transaction, further steps may be executed. For instance, referring now to FIG. 5, a method 500 of performing a cryptocurrency transaction with a secure browser extension cryptowallet system may be provided. The method 500 may include a user entering a cryptocurrency transaction on the browser extension wallet running on the browser device (block 502). The browser extension wallet running on the browser device may send the cryptocurrency transaction to the hardware wallet dongle connected to the browser device via a first communication interface (block 504). The secure element of the hardware wallet dongle receives the transaction, parses the transaction, and generates a visible representation of the transaction (block 506). In various embodiments, the visible representation comprises a transaction amount and a receiver address. The secure element then causes the hardware wallet dongle to send a notification to the authentication device (block 508). For example, the hardware wallet dongle may send an app push notification to a smartphone and may send the visible representation to the smartphone. In response, the user opens the app notification on the authentication device so that the user may view the visible representation (block 510). The user may interact with the sensor to confirm that the visual representation of the transaction on the authentication device is accurate (block 512). This interaction may take various forms. For instance, a user may press a button. The user may enter a PIN code on the authentication device via a touch screen of the authentication device. The user may provide biometric information such touching the sensor to confirm a fingerprint or looking at the sensor to confirm facial recognition. The sensor may be on the authentication device. The sensor may be on the hardware wallet dongle. In response to the interaction, the transaction is confirmed as accurate, and in various embodiments, the identity of the user is confirmed as authorized. Thus, in response to the interaction, the sensor of the authentication device (e.g., smartphone application) sends a signature confirmation to the hardware wallet dongle, and more specifically, a secure element of the hardware wallet dongle. Stated differently, the secure element receives a first authentication message from the second communication interface, the first authentication message corresponding to a verification by the authentication device of an identity of the user (block 514). The secure element may sign the transaction using a private key in response to the first authentication message (block 516). The secure element may transmit the signed transaction to the browser extension wallet via the first communication interface, for writing the signed transaction to a blockchain by the browser extension wallet (block 518). The browser extension wallet receives the signed transaction and publishes the signed transaction to a blockchain to complete a transaction (block 520).

Moreover, a user may further establish a signing policy of the hardware wallet dongle, such as including a receiver whitelist or blacklist, a transaction amount limit, a destination address selection criteria, or other requirements.

The present disclosure has been described with reference to various embodiments. However, one of ordinary skill in the art appreciates that various modifications and changes can be made without departing from the scope of the present disclosure. For example, features of different embodiments may be combined. Accordingly, the specification is to be regarded in an illustrative rather than a restrictive sense, and all such modifications are intended to be included within the scope of the present disclosure.

For the sake of brevity, conventional techniques for manufacturing and construction may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical method of construction. As used herein, mechanical communication means any joint, connection, bond, or arrangement whereby an article is held, retained, or fixed in relatively static spatial relationship to another article. As used herein, electronic communication means any wired, wireless, analog, digital, or other mechanism whereby information is communicated between machines, circuits, or devices.

Benefits, other advantages, and solutions to problems have been described herein with regard to various embodiments. However, the benefits, advantages, solutions to problems, and any elements that may cause any benefit, advantage, or solution to occur or become more pronounced are not to be construed as critical, required, or essential features or elements of the invention. Moreover, where a phrase similar to “at least one of A, B, and C” or “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

As used herein, the singular forms “a,” “an,” and “the” include plural referents unless the context clearly dictates otherwise. As used herein, the terms “for example,” “for instance,” “such as,” or “including” are meant to introduce examples that further clarify more general subject matter. Unless otherwise specified, these examples are embodiments of the present disclosure, and are not meant to be limiting in any fashion.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A hardware wallet dongle for a secure browser extension cryptowallet system for securing cryptocurrency transactions in a browser extension wallet, the hardware wallet dongle comprising:
a secure element configured to protect a private key of a user;
a first communication interface to connect the hardware wallet dongle in electronic communication with a browsing device running the browser extension wallet; and
a second communication interface to connect the hardware wallet dongle in electronic communication with an authentication device,
wherein the first communication interface and the second communication interface are both connected to the secure element, and
wherein the secure element signs a transaction and transmits a signed transaction to the first communication interface for provision to the browser extension wallet in response to a first authentication message from the authentication device being received by the second communication interface and verified by the secure element as authentic.

2. The hardware wallet dongle of claim 1, wherein the authentication device is a smartphone.

3. The hardware wallet dongle of claim 1, wherein the first communication interface is a wired interface.

4. The hardware wallet dongle of claim 3, wherein the wired interface is a Universal Serial Bus interface.

5. The hardware wallet dongle of claim 1, wherein the second communication interface is a wireless interface.

6. The hardware wallet dongle of claim 1, wherein the hardware wallet dongle does not include a screen display.

7. The hardware wallet dongle of claim 1, wherein the hardware wallet dongle includes no human-readable interface.

8. The hardware wallet dongle of claim 1, wherein the first authentication message comprises a confirmation of a user identity by at least one biometric sensor.

9. A secure browser extension cryptowallet system for securing cryptocurrency transactions in a browser extension wallet, the system comprising:
a hardware wallet dongle comprising:
a secure element configured to protect a private key of a user;
a first communication interface to connect the hardware wallet dongle in electronic communication with a browsing device running the browser extension wallet; and
a second communication interface to connect the hardware wallet dongle in electronic communication with an authentication device,
wherein the first communication interface and the second communication interface are both connected to the secure element,
wherein the secure element signs a transaction and transmits a signed transaction to the first communication interface for provision to the browser extension wallet in response to a first authentication message from the authentication device being received by the second communication interface and verified by the secure element as authentic;
the browsing device configured to run the browser extension wallet, wherein the browsing device is connected to a network having access to a blockchain to write the signed transaction to the blockchain; and
a smartphone configured to run a smartphone application comprising the authentication device, wherein the authentication device includes a sensor and wherein the first authentication message is an authentication of an identity of the user by the sensor.

10. The secure browser extension cryptowallet system of claim 9, wherein the sensor is a fingerprint sensor.

11. The secure browser extension cryptowallet system of claim 9, wherein the sensor is a facial recognition sensor.

12. The secure browser extension cryptowallet system of claim 9, wherein the browsing device is a commodity PC.

13. The secure browser extension cryptowallet system of claim 9, wherein the sensor is a touch screen for entering a PIN code.

14. The secure browser extension cryptowallet system of claim 9, wherein the first communication interface is a wired interface.

15. The secure browser extension cryptowallet system of claim 14, wherein the wired interface is a Universal Serial Bus interface.

16. The secure browser extension cryptowallet system of claim 9, wherein the second communication interface is a wireless interface.

17. The secure browser extension cryptowallet system of claim 9, wherein the hardware wallet dongle does not include a screen display.

18. The secure browser extension cryptowallet system of claim 9, wherein the hardware wallet dongle includes no human-readable interface.

19. A method of performing a cryptocurrency transaction with secure browser extension cryptowallet system for securing cryptocurrency transactions in a browser extension wallet, the method comprising:
sending, by the browser extension wallet running on a browser device, the cryptocurrency transaction to a hardware wallet dongle connected to the browser device via a first communication interface;
receiving, by a secure element of the hardware wallet dongle, the cryptocurrency transaction, parsing the cryptocurrency transaction, and generating a visible representation of the cryptocurrency transaction;
sending, by the secure element, the visible representation to a second communication interface wirelessly connectable to an authentication device;
receiving, by the secure element, a first authentication message from the second communication interface, the first authentication message corresponding to a verification by the authentication device of an identity of a user;
signing, by the secure element, the cryptocurrency transaction in response to the first authentication message; and
transmitting, by the secure element, a signed cryptocurrency transaction to the browser extension wallet via the first communication interface, for writing the signed cryptocurrency transaction to a blockchain by the browser extension wallet.

20. The method according to claim 19, wherein the visible representation comprises a transaction amount and a receiver address.
